(19) United States
(12) Patent Application Publication
(10) Pub. No.: US 2026/0217892 A1
(43) Pub. Date: Jul. 30, 2026

(54) FIRE RETARDANT MATERIAL

(71) Applicant: KING FAHD UNIVERSITY OF PETROLEUM AND MINERALS, Dhahran (SA)

(72) Inventors: Mohammad Mizanur RAHMAN, Dhahran (SA); Aasif HELAL, Dhahran (SA); Dhafer Abdullah AL SHEHRI, Dhahran (SA); Bashirul HAQ, Dhahran (SA)

(73) Assignee: KING FAHD UNIVERSITY OF PETROLEUM AND MINERALS, Dhahran (SA)

(21) Appl. No.: 19/044,416

(22) Filed: Feb. 3, 2025

(30) Foreign Application Priority Data
Jan. 29, 2025 (SA) 1020250608

(51) Int. Cl. C08G 18/12; C07F 7/00; C08G 18/08; C08G 18/24; C08G 18/32; C08G 18/48; C08G 18/50; C23C 22/03

(52) U.S. Cl. CPC C08G 18/12; C07F 7/00; C08G 18/0871; C08G 18/244; C08G 18/3206; C08G 18/4808; C08G 18/4854; C08G 18/5084; C23C 22/03; C08G 2150/00

(57) ABSTRACT

A fire-retardant material including a polymer matrix including, in reacted form, a diisocyanate, a chain extender, a carboxylate-comprising organic diol, an organophosphorus-containing polyol, an organophosphorus-free polyol. The diisocyanate and phosphorous-containing polyol are present in the polymer matrix a mole ratio of 1:1 to 50:1. The fire-retardant material includes 0.05 to 2.5 wt. % a metal-organic framework, based on a total weight of fire-retardant material. The fire-retardant material shows enhanced protection of metal surfaces from hydrogen embrittlement and may find use as a coating on a material exposed to hydrogen or a hydrogen-containing gas mixture.

### CROSS-REFERENCE TO RELATED APPLICATION

The present disclosure claims the benefit of Saudi patent application Ser. No. 1020250608, filed on Jan. 29, 2025, with the Saudi Authority for Intellectual Property Office, which is incorporated herein by reference in its entirety.

### BACKGROUND

### Technical Field

The present invention relates to a polyurethane-comprising coating for use as a fire-retardant material.

### Description of Related Art

The ‘background’ description provided herein presents the context of the disclosure generally. The work of the presently named inventors, to the extent it is described in this background section, as well as aspects of the description that may not otherwise qualify as prior art at the time of filing, are neither expressly nor impliedly admitted as prior art against the present invention.

Polyurethane (PU) has emerged as a highly promising material for protective coatings due to its exceptional chemical resistance, mechanical strength, flexibility, thermal stability, and resistance to tear and scratch. Extensive research has focused on combining PU with multifunctional groups to enhance its applicability across various industrial sectors. The performance of PU coatings has been found to be dependent on factors such as the nature and ratio of the monomers used, allowing for the design of coatings with specific attributes, such as anticorrosion, antifouling, and flame-retardant properties.

The versatility in monomer selection contributes to the wide applicability of PU in coatings, resulting in materials with tailored properties that exhibit good mechanical characteristics, anti-corrosive behavior, and high hydrophilicity. Recent advancements have further expanded the use of PU, including the development of PU combined with metal-organic frameworks (MOFs) for specialized applications such as gas separation and dye removal.

Despite these applications of PU coatings, there are many applications where PU coatings are not available or are not suitable, particularly regarding thermal stability and mechanical resistance. While thermoplastic PU coatings exhibit flexibility, they are susceptible to high-temperature degradation and mechanical strains. In contrast, thermoset PU coatings, characterized by crosslinked structures, offer enhanced tensile strength and improved resistance to various environmental factors, making them preferable for industrial applications. Efforts to improve the solid content of solvent-borne coatings continue to address these challenges by minimizing organic solvent use and enhancing coating performance.

One rapidly growing area of polymeric coatings is in coatings for materials related to hydrogen storage and/or transfer. Hydrogen is notoriously difficult to handle and store because it can cause embrittlement of metals if bare metals come into contact with the hydrogen and it is flammable, creating large fire and explosion risks. Hydrogen being so small makes it difficult to adequately protect a material from exposure. The hydrogen molecules can pass through a wide variety of materials.

Accordingly, one object of the present disclosure is to provide a polyurethane coating that may be useful in applications related to hydrogen storage, transport, and/or handling.

### SUMMARY

According to a first aspect, the present disclosure relates to a fire-retardant material. In some embodiments, the fire-retardant material includes a polymer matrix including, in reacted form, a diisocyanate, a chain extender, a carboxylate-including organic diol, an organophosphorus-containing polyol, an organophosphorus-free polyol. In some embodiments, the diisocyanate and phosphorous-containing polyol are present in the polymer matrix a mole ratio of 1:1 to 50:1. In some embodiments, the fire-retardant material includes 0.05 to 2.5 wt. % a metal-organic framework, based on a total weight of fire-retardant material.

In some embodiments, the diisocyanate is 4,4-dicyclohexylmethane diisocyanate, the chain extender is ethylene diamine, and the carboxylate-including organic diol is dimethylolpropionic acid.

In some embodiments, the polymer matrix includes 18 to 30 mol % dimethylolpropionic acid.

In some embodiments, the organophosphorus-containing polyol has a structure represented by the following formula (1)

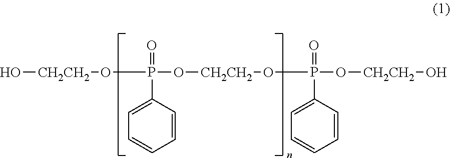

where n is an integer from 1 to 100,000.

In some embodiments, the organophosphorus-free polyol is poly(tetramethyleneoxide glycol).

In some embodiments, the fire-retardant material has a mole ratio of the organophosphorus-free polyol and the organophosphorus-containing polyol of 1:1 to 5:1.

In some embodiments, the metal-organic framework is UiO-66-OH.

In some embodiments, the fire-retardant material has a water swelling of 5.0 to 9.0% and a water contact angle of 70 to 100°.

In some embodiments, the fire-retardant material has a shore a hardness of 70 to 85, a tensile strength of 22.5 to 29.5 Mpa, and a young's modulus of 3 to 10 MPa.

In some embodiments, the fire-retardant material has a limiting oxygen index of 22.5 to 35 and a residue char of 7.5 to 15 wt. % based on an initial weight of fire-retardant material.

The present disclosure also relates to a method of forming the fire-retardant material. In some embodiments, the method includes forming a short-chain prepolymer by reacting 4,4-dicyclohexylmethane diisocyanate, dimethylolpropionic acid, the organophosphorus-containing polyol, and the organophosphorus-free polyol in the presence of a polymerization catalyst. In some embodiments, the method includes dispersing the short-chain prepolymer in water to form a short-chain prepolymer dispersion. In some embodiments, the method further includes chain extending the short-chain prepolymer by reacting the short-chain prepolymer with ethylene diamine to form a chain-extended poly(urethane) dispersion. In some embodiments, the method further includes mixing the chain-extended poly(urethane) dispersion with the metal-organic framework to form a mixed dispersion. In some embodiments, the method further includes drying the mixed dispersion to form the fire-retardant material.

In some embodiments, the chain-extended poly(urethane) dispersion has a solid content of 20 to 45 wt. % based on a total weight of chain-extended poly(urethane) dispersion.

In some embodiments, the organophosphorus-free polyol is poly(tetramethyleneoxide glycol).

In some embodiments, the organophosphorus-containing polyol has a structure represented by the following formula (1)

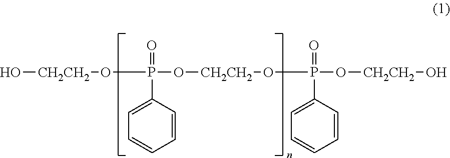

where n is an integer from 1 to 100,000.

In some embodiments, the metal-organic framework is UiO-66-OH.

In some embodiments, the polymerization catalyst is dibutyltin dilaurate.

In some embodiments, the method of forming the short-chain prepolymer is performed at a polymerization temperature of 70 to 100° C. and the chain extending is performed at a chain extension temperature of 25 to 60° C.

In some embodiments, a method of passivating a surface against hydrogen embrittlement is described. The method including applying to the surface the fire-retardant material.

In some embodiments, the fire-retardant material is applied to the surface as a coating having a thickness of 25 to 500 μm.

In some embodiments, the fire-retardant material shows no detectable change in Fourier Transform Infrared (FTIR) peak positions after exposure to a gas mixture including 10 to 90% hydrogen for 1 to 96 hours, compared to FTIR peak positions of the fire-retardant material prior to the exposure.

The foregoing general description of the illustrative present disclosure and the following detailed descriptions thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a flow chart depicting a method of forming a fire-retardant material, according to some embodiments.

FIGS. 2A-2B are images depicting polyurethane metal-organic-framework (PU/MOF) before stirring, according to some embodiments.

FIG. 2C is an image depicting PU/MOF after stirring, according to some embodiments.

FIGS. 3A-3C are images depicting PU/MOF in a Teflon disk, according to some embodiments.

FIG. 4A is a pictorial image depicting wet coatings of the fire-retardant material of about of about 100 μm thickness on a metal surface, according to some embodiments.

FIG. 4B is a pictorial image depicting wet coatings of the fire-retardant material of about of about 150 μm thickness on a metal surface, according to some embodiments.

FIG. 5 is Fourier transform infrared spectroscopy (FT-IR) spectra of PU, PU/MOF, and MOF coatings, according to some embodiments.

FIG. 6 is thermal gravimetric analysis (TGA) thermograms of the PU and PU/MOF coatings, according to certain embodiments.

FIG. 7 depicts potentiodynamic polarization (PDP) analysis of PU and PU/MOF coatings, according to some embodiments.

FIGS. 8A-8B depicts photographs of unexposed and exposed coatings, according to some embodiments.

FIG. 8C is FT-IR spectra of PU4/PP4-MOF4 coatings, according to some embodiments.

FIG. 9 is X-ray diffraction (XRD) spectra of PU4/PP4-MOF4 coatings at different exposed conditions, according to some embodiments.

FIG. 10A is a scanning electron microscope (SEM) microphotograph of PU4/PP4-MOF4 coating at 0% exposed condition of hydrogen blended gas, according to some embodiments.

FIG. 10B is a SEM microphotograph of PU4/PP4-MOF4 coating at 10% exposed condition of hydrogen blended gas, according to some embodiments.

FIG. 10C is a SEM microphotograph of PU4/PP4-MOF4 coating at 20% exposed condition of hydrogen blended gas, according to some embodiments.

FIG. 10D is a SEM microphotograph of PU4/PP4-MOF4 coating at 40% exposed condition of hydrogen blended gas, according to some embodiments.

FIG. 10E is a SEM microphotograph of PU4/PP4-MOF4 coating at 60% exposed condition of hydrogen blended gas, according to some embodiments.

FIG. 10F is a SEM microphotograph of PU4/PP4-MOF4 coating at 80% exposed condition of hydrogen blended gas, according to some embodiments.

FIG. 10G is a SEM microphotograph of PU4/PP4-MOF4 coating at 100% exposed condition of hydrogen blended gas, according to some embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Embodiments of the present disclosure will now be described more fully hereinafter with reference to the accompanying drawings, in which some, but not all embodiments of the disclosure are shown.

As used herein, the words “about,” “approximately,” or “substantially similar” may be used when describing magnitude and or position to indicate that the value and/or position described is within a reasonable expected range of values and/or positions. For example, a numeric value may have a value that is +/−0.1% of the stated value (or range of values), +/−1% of the slated value (or range of values), +/−2% of the stated value (or range of values), +/−5% of the slated value (or range of values), +/−10% of the staled value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

The present disclosure is intended to include all hydration states of a given compound or formula, unless otherwise noted or when heating a material.

As used herein, the term “phophol” or “phosphorylated polyol” may be used interchangeably throughout the draft.

As used herein, the term “polyurethane” includes “poly(urethane-urea)”.

According to a first aspect, the present disclosure relates to a fire-retardant material. A fire-retardant material is typically characterized as difficult to burn or carbonize at high temperatures. In some embodiments, the fire-retardant material serves dual functions as an external coating for flame retardance as well as an internal coating over a surface to lower diffusion rate of gases (for example of hydrogen or hydrogen-containing gas mixtures). In some embodiments, the fire-retardant material may be useful for reducing the susceptibility of the surface to hydrogen embrittlement.

In some embodiments, the material of the present disclosure includes a polymer matrix, and a metal-organic framework (MOF) dispersed in the polymer matrix. In some embodiments, the polymer matrix includes a polyurethane. Typically, a polyurethane is formed of at least three main components—i) a diisocyanate, ii) a chain extender, and iii) a polyol. In some embodiments, the polyol includes any of a carboxylate-comprising organic diol, an organophosphorus-containing polyol, and an organophosphorus-free polyol. In some embodiments, the three components in the polymer matrix are in a reacted form, to form a polyurethane and/or poly(urethane-urea) backbone.

### Diisocyanate

Diisocyanates are highly reactive compounds that react with the hydroxyl groups in polyols and chain extenders to form the polymer matrix. In general, any suitable diisocyanate can be employed. In some embodiments, the diisocyanate may be aromatic, aliphatic, or a mixture of these. Examples of suitable aromatic diisocyanates include the 4,4′-, 2,4′- and 2,2′-isomers of diphenylmethane diisocyante (MDI), blends thereof and polymeric and monomeric MDI blends toluene-2,4- and 2,6-diisocyanates (TDI), m- and p-phenylenediisocyanate (pMDI), chlorophenylene-2,4-diisocyanate, diphenylene-4,4′-diisocyanate, 4,4′-diisocyanate-3,3′-dimethyldiphenyl, 3-methyldiphenyl-methane-4,4′-diisocyanate and diphenylether diisocyanate and 2,4,6-triisocyanatotoluene and 2,4,4′-triisocyanatodiphenylether. In some embodiments, the diisocyanate may include pre-polymers of TDI, MDI, or pMDI. Examples of suitable aliphatic diisocyanates include, but are not limited to, ethylene diisocyanate, 1,6-hexamethylene diisocyanate, isophorone diisocyanate, cyclohexane 1,4-diisocyanate, 4,4′-dicyclohexylmethane diisocyanate, and/or combinations thereof. In some embodiments, the diisocyanate is aliphatic. In some embodiments, the diisocyanate is 4,4-dicyclohexylmethane diisocyanate.

In some embodiments, the molar percentage of diisocyanate present may be in the range of about 1% to about 10%, preferably from about 2% to about 7%, preferably from about 3% to about 5%, preferably about 4% of the total weight of the fire-retardant material.

### Chain Extenders

Chain extenders, usually diols or amines, are generally added to fire-retardant materials to link the polymer chains in the polymer matrix. The hydroxyl and amine functional groups may help promote cross-linking within the polymer matrix, thereby increasing its overall molecular weight. Such cross-linking may also result in a dense, polymeric, stable structure, that may be useful in withstanding heat and flame.

In general, like the diisocyanate above, the chain extenders can be either aliphatic or aromatic. Suitable examples of chain extenders include, but are not limited to, low-molecular-weight polyhydric alcohols such as ethylene glycol, diethylene glycol, 1,4-butanediol, and glycerine; low-molecular-weight amines such as diethanolamine and triethanolamine; and polyamines such as ethylene diamine, ethylenediamine, and methylene-bis(o-chloroaniline). In some embodiments, the chain extender is an aliphatic amine. In some embodiments, the chain extender is ethylene diamine.

In some embodiments, the molar percentage of the chain extender may be between about 0.1% and about 1%, preferably between about 0.2% and more preferably about 0.7%, of the total weight of the fire-retardant material

### Polyol

The term “polyol” refers to a molecule that has at least two or more functional hydroxyl groups that can react with isocyanate groups to form urethane groups. Examples of polyols include but are not limited to diols, triols, and macromers such as macrodiols. In some embodiments, the material of the present disclosure includes an organic diol with a carboxylic acid group (a carboxylate comprising organic diol). In some embodiments, the material of the present disclosure includes an organophosphorus-containing polyol. In some embodiments, the material of the present disclosure includes an organophosphorus-free polyol. In some embodiments, the material of the present disclosure includes an organophosphorus-containing polyol and any an organic diol with a carboxylic acid group (a carboxylate comprising organic diol) and an organophosphorus-free polyol.

### Carboxylate Comprising Organic Diols

In general, the carboxylate comprising organic diol can be any suitable organic diol that also contains a carboxylate group. Carboxylate comprising organic diols may be used in the formation of polyurethane or poly(urethane urea) polymers to introduce ionizable groups which may increase dispersibility, dispersion stability, or water solubility to polymers or prepolymers. Examples of suitable carboxylate comprising organic diols include, but are not limited to, 2,2-bis(hydroxymethyl) propionic acid (“dimethylolpropionic acid”), 3,11-dihydroxydodecanoic acid, 2,3-dihydroxy-3-methylpentanoic acid, 3,10-dihydroxydecanoic acid, 3,5-dihydroxy-3-methylpentanoic acid, and 2,2-bis(hydroxymethyl) butyric acid. In some embodiments, the carboxylate comprising organic diols is dimethylolpropionic acid.

In some embodiments, the mole percent of the carboxylate comprising organic diols is in the range of 18-30 mol % based on the total weight of the polymer matrix. In some embodiments, the mole percent of the carboxylate comprising organic diols is 18.5 mol %, 19.0 mol %, 19.5 mol %, 20.0 mol %, 20.5 mol %, 21.0 mol %, 21.5 mol %, 22.0 mol %, 22.5 mol %, 23.0 mol %, 23.5 mol %, 24.0 mol %, 24.5 mol %, 25.0 mol %, 25.5 mol %, 26.0 mol %, 26.5 mol %, 27.0 mol %, 27.5 mol %, 28.0 mol %, 28.5 mol %, 29.0 mol %, 29.5 mol %, or 30 mol % based on the total weight of the polymer matrix.

### Organophosphorus-Containing Polyol

In general, the organophosphorus-containing polyol can be any suitable polyol that also contains an organophosphorus group. In general, the organophosphorus group can be any suitable organophosphorus group. Examples of organophosphorus groups include, but are not limited to, organophosphates such as phosphate esters and phosphate amides, phosphonic acids, phosphonic esters, phosphinic acids, phosphinic esters, phosphine oxides, phosphine imides, phosphine chalcogenides, phosphonium salts, phosphoranes, phosphites, phosphonites, phosphinites, phosphines, phosphoalkenes, phosphoalkynes, and combinations of these. In some embodiments, the organophosphorus group is a phosphonate. A phosphonate is an organophosphorus group having a general structure shown in formula (II) below.

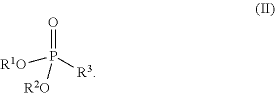

In formula (II), R¹, R², and R³ can each independently be any suitable carbon-containing organic group. In addition, R¹ and R² can each independently be hydrogen.

In some embodiments, the organophosphorus-containing polyol comprises a polymeric polyol. The polymeric polyol can include a polymeric polyol backbone, such as a polyether backbone in a polyether polyol or a polyester backbone in a polyester polyol. In some embodiments, the organophosphorus group is present as an organophosphorus group linked as a pendant functional group connected to the polyol backbone. For example, the organophosphorus group can be present as a pendant formed by a suitable covalent connection to a hydroxyl functional group, a carboxylate functional group, an amine functional group, or some other type of functional group present connected to the polyol backbone. Such a functional group present connected to the polyol backbone can be a terminal functional group or a non-terminal functional group. In some embodiments, the organophosphorus group is present as an organophosphorus group integrated into the backbone of the organophosphorus-comprising polyol. That is, the polyol backbone itself contains a covalent linkage that includes the phosphorous atom of the organophosphorus group. In general, the polyol portion of the phosphate comprising polyol can include any suitable polyol backbone. For example, the phosphate comprising polyol can include polyethylene glycol, polypropylene glycol, polybutylene glycol, and the like.

In some embodiments, the phosphate comprising polyol has a structure represented by the following formula (I)

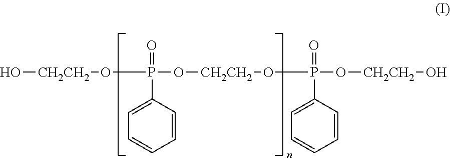

In formula (I) n is an integer from 1 to 100,000. In some embodiments, n is 5, 10, 15, 20, 25, 50, 75, 100, 125, 225, 250, 275, 300, 325, 350, 375, 400, 425, 450, 475, 500, 550, 600, 650, 700, 750, 800, 850, 900, 950, 1000, 1100, 1200, 1300, 1400, 1500, 1750, 1900, 2000, 2250, 2500, 2750, 3000, 3250, 3500, 3750, 4000, 4250, 4500, 4750, 5000, 5250, 5500, 5750, 6000, 6250, 6500, 6750, 7000, 7250, 7500, 7750, 8000, 8250, 8500, 8750, 9000, 9250, 9500, 9750, 10,000, 11,000, 12,000, 13,000, 14,000, 15,000, 16,000, 17,000, 18,000, 19,000, 20,000, 21,000, 22,000, 23,000, 24,000, 25,000, 26,000, 27,000, 28,000, 29,000, 30,000, 32,000, 34,000, 36,000, 38,000, 40,000, 42,000, 44,000, 46,000, 48,000, 50,000, 55,000, 60,000, 65,000, 70,000, 75,000, 80,000, 85,000, 90,000, 95,000, or 100,000.

### Organophosphorus-Free Polyol

In general, the organophosphorus-free polyol can be any suitable polyol that does not include an organophosphorus group. In some embodiments, the organophosphorus-free polyols may be polyether polyols, polyester polyols, modified polyols, such as sorbitol-based polyols or glycerin-based polyols. Suitable examples of polyether polyols include, but are not limited to, poly(tetramethylene) glycol (PTMO), poly(propylene oxide) (PPO), and poly(ethylene) glycol (PEG). Suitable examples of polyester polyols include, but are not limited to, poly(ethylene gluatarate), poly(ethylene adipate), poly(ethylene azelate), poly(trimethylene glutarate) etc. In some embodiments, the organophosphorus-free polyol is poly(tetramethyleneoxide glycol) (“PTMG”). In some embodiments, the average molecular weight of PTMG is 100 to 5000 g/mol, preferably 500 to 4000 g/mol, preferably 1000 to 3000 g/mol, preferably about 2000 g/mol.

In some embodiments, the molar ratio of the organophosphorus-free polyol to the organophosphorus-containing polyol is 1:1 to 5:1, preferably 1.25:1 to 3:1, preferably 1.5:1 to 2.75:1, preferably 1.75:1 to 2.5:1, preferably 2:1 to 2.25:1, preferably 2.125:1.

In some embodiments, the diisocyanate and phosphorous-containing polyol is present in the polymer matrix, a molar ratio of 1:1 to 50:1, preferably 2:1 to 40:1, preferably 3:1 to 35:1, preferably 4:1 to 30:1, preferably 5:1 to 25:1, preferably 6:1 to 20:1, preferably 7:1 to 15:1, preferably 8:1 to 13:1, preferably 9:1 to 11:1, preferably 10:1.

### Polyurethane

In some embodiments, the components described above react together to form the polyurethane backbone. In some embodiments, the polyurethane structure formed by the reaction between the diisocyanates, chain extenders, and polyols (without the organophosphorus-containing polyol) is depicted below in formula (III):

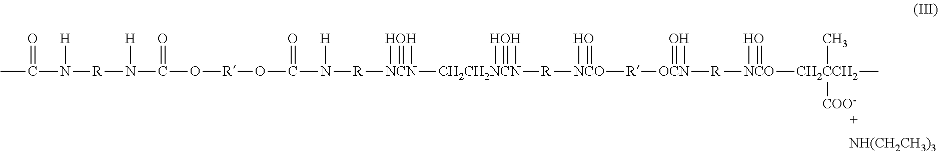

In some embodiments, the polyurethane structure formed by the reaction between the diisocyanates, chain extenders, and polyols (with the organophosphorus-containing polyol) is depicted below in formula (IV):

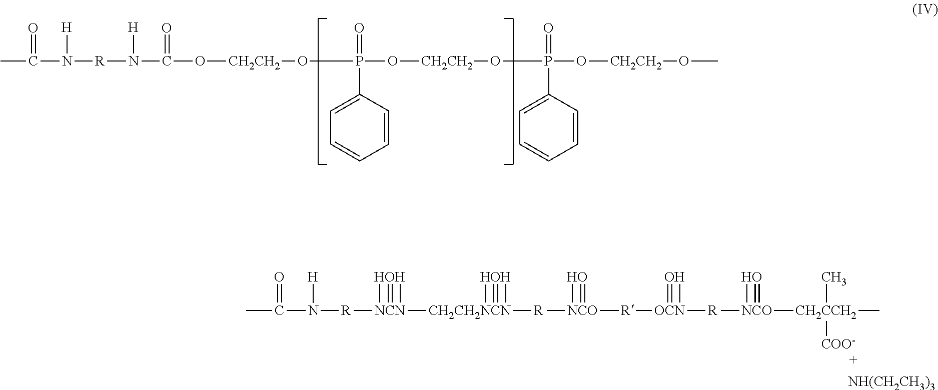

In some embodiments, the polymer matrix includes both of the above structures. In some embodiments, the polyurethane comprises urea linkages. Such urea linkages may be present, for example, between polyurethane chains.

### Metal-Organic Framework

The International Union of Pure and Applied Chemistry (IUPAC) states that a metal organic framework (MOF) is a coordination network with organic ligands containing potential voids. A coordination network is a coordination compound extending, through repeating coordination entities, in one dimension, but with cross-links between two or more individual chains, loops, or spiro-links, or a coordination compound extending through repeating coordination entities in two or three dimensions; and a coordination polymer is a coordination compound with repeating coordination entities extending in one, two, or three dimensions. A coordination entity is an ion or neutral molecule that is composed of a central atom, usually that of a metal, to which is attached a surrounding array of atoms or groups of atoms, each of which is called ligands. More succinctly, a metal organic framework is characterized by metal ions or clusters coordinated to organic ligands to form one-, two-, or three-dimensional structures. Typically, a MOF exhibits a regular void or pore structure. The nature of the void or pore structure, including properties or structural factors such as the geometry about the metal ions or clusters, the arrangement of the linkages between metal ions or clusters, and the number, identity, and spatial arrangement of voids or pores. These properties may be described as the structure of the repeat units and the nature of the arrangement of the repeat units. The specific structure of the MOF, which may include the void or pore structure is typically referred to as the MOF topology.

The metal-organic framework comprises a metal ion which is an ion of at least one metal selected from the group consisting of a transition metal (e.g. Sc, Ti, V, Cr, Mn, Fe, Co, Ni, Cu, Y, Zr, Nb, Mo, Tc, Ru, Rh, Pd, Ag, Hf, Ta, W, Re, Os, Ir, Pt, Au, Rf, Db, Sg, Bh, Hs, Mt, Ds, Rg, and Cn), a post-transition metal (e.g. Al, In, Ga, Sn, Bi, Pb, Tl, Zn, Cd, and Hg), and an alkaline earth metal (e.g. Be, Mg, Ca, Sr, Ba, and Ra). Further, these metal ions may be of any oxidation state M⁺¹, M⁺², M⁺³, etc. In one or more embodiments, the metal ion is an ion of at least one metal selected from the group consisting of Zn, Cu, Fe, Ni, Co, Mn, Cr, Cd, Mg, Ca, and Zr.

In the formation of a metal organic framework, the organic ligands must meet certain requirements to form coordination bonds, primarily being multi-dentate, having at least two donor atoms (i.e. N—, and/or O—) and being neutral or anionic. The structure of the metal organic framework is also affected by the shape, length, and functional groups present in the organic linker. For example, the organic ligands may be imidazolate-based, imidazole-derived or ligands similar to an imidazole including, but not limited to, optionally substituted imidazoles, optionally substituted benzimidazoles, optionally substituted imidazolines, optionally substituted pyrazoles, optionally substituted thiazoles, and optionally substituted triazoles.

Examples of suitable MOFs include, but are not limited to MOF-74, MOF-101, MOF-1777, MOF-225, MOF-253, IFMOF-1, IRMOF-16, UiO-60, UiO-66, UiO-67, UiO-68, MIL-53, MIL-53 (Al)—NH₂, MIL-88A, MIL-88-Fe, MIL-100-Fe, MIL-101, HKUST-1, LIC-1, ZIF-8, ZIF-90, CPL-2, F-MOF-1, and MOP-1. In some embodiments, the MOF is a UiO-66-based MOF. In some embodiments, the MOF is a functionalized MOF. A functionalized MOF is a MOF that has accessible functional groups available for interacting with other chemical species that are not the MOF. Such accessible functional groups can include, but are not limited to, aldehyde groups, carboxylic acid groups, hydroxy groups, amine groups, and the like. some embodiments, the MOF is a hydroxy-functionalized MOF. Examples of hydroxy-functionalized MOFs include, but are not limited to MIL-101, ZIF-8, MOF-5, ZIF-67, NH₂-MIL-125, Mg-MOF-74, UiO-66-OH and UiO-66-(OH) 2. In some embodiments, the MOF is UiO-66-OH. In some embodiments, the MOF is UiO-66-(OH) 2.

UiO-66 and its corresponding functionalized MOF versions show a thermal stability, capable of withstanding temperatures up to 500° C. It also shows a chemical stability against various different polar and organic solvents, such as water, acetone, methanol, benzene, dimethylformamide, and chloroform [P. S. Bárcia, et. al., Microporous, and Mesoporous Materials 139 (2011) 67-73; and J. B. DeCoste, et. al., J. Mater. Chem. A 1 (2013) 11922-11932, each of which is incorporated herein by reference in its entirety]. Furthermore, it has demonstrated crystallinity preservation when treated with harsh solutions such as aqueous HCl (pH=1) and aqueous NaOH (pH=14) whilst also maintaining its structural integrity under certain mechanical pressures [M. Kandiah, et. al., Chem. Mater. 22 (2010) 6632-6640; and H. Wu, et. al., J. Phys. Chem. Lett. 4 (2013) 925-930, each of which is incorporated herein by reference in its entirety].

In some embodiments, the MOF is present as particles. In general, the MOF particles can be any shape known to one of ordinary skill in the art. Examples of suitable shapes the MOF particles may take include spheres, spheroids, lentoids, ovoids, solid polyhedra such as tetrahedra, cubes, octahedra, icosahedra, dodecahedra, hollow polyhedra (also known as microcages or nanocages), stellated polyhedra (both regular and irregular, also known as microstars or nanostars), triangular prisms (also known as nanotriangles), hollow spherical shells (also known as microshells or nanoshells), tubes (also known as microtubes or nanotubes), sheets, microsheets, nanosheets, platelets, microplatelets, nanoplatelets, disks, microdisks, nanodisks, rods (also known as microrods or nanorods), and mixtures thereof. In the case of microrods or nanorods, the rod shape may be defined by a ratio of a rod length to a rod width, the ratio being known as the aspect ratio. For MOF particles of the current invention, microrods or nanorods should have an aspect ratio less than 1000, preferably less than 750, preferably less than 500, preferably less than 250, preferably less than 100, preferably less than 75, preferably less than 50, preferably less than 25.

In some embodiments, the MOF particles have uniform shape. Alternatively, the shape may be non-uniform. As used herein, the term “uniform shape” refers to an average consistent shape that differs by no more than 10%, by no more than 5%, by no more than 4%, by no more than 3%, by no more than 2%, by no more than 1% of the distribution of MOF particles having a different shape. As used herein, the term “non-uniform shape” refers to an average consistent shape that differs by more than 10% of the distribution of MOF particles having a different shape. In one embodiment, the shape is uniform and at least 90% of the $$ are spherical or substantially circular, and less than 10% are polygonal. In another embodiment, the shape is non-uniform and less than 90% of the MOF particles are spherical or substantially circular, and greater than 10% are polygonal.

In some embodiments, the MOF particles have a mean particle size of 5 nm to 10 μm. For example the MOF particles can have a mean particle size of 10 nm, 15 nm, 20 nm, 25 nm, 50 nm, 75 nm, 100 nm, 150 nm, 200 nm, 250 nm, 300 nm, 350 nm, 400 nm, 450 nm, 500 nm, 600 nm, 700 nm, 800 nm, 900 nm, 1000 nm, 1250 nm, 1500 nm, 1750 nm, 2.0 μm, 2.25 μm, 2.5 μm, 2.75 μm, 3.0 μm, 3.25 μm, 3.5 μm, 3.75 μm, 4.0 μm, 4.25 μm, 4.5 μm, 4.75 μm, 5.0 μm, 5.5 μm, 6.0 μm, 6.5 μm, 7.0 μm, 7.5 μm, 8.0 μm, 8.5 μm, 9.0 μm, 9.5 μm, or 10 μm. In embodiments where the MOF particles are spherical, the particle size may refer to a particle diameter. In embodiments where the MOF particles are polyhedral or some other non-spherical shape, the particle size may refer to the diameter of a circumsphere. In some embodiments, the particle size refers to a mean distance from a particle surface to particle centroid or center of mass. In alternative embodiments, the particle size refers to a maximum distance from a particle surface to a particle centroid or center of mass. In some embodiments where the MOF particles have an anisotropic shape such as microrods or nanorods, the particle size may refer to a length of the microrod or nanorod, a width of the microrod or nanorod, or an average of the length and width of the microrod or nanorod. In some embodiments in which the MOF particles have non-spherical shapes, the particle size may refer to the diameter of a sphere having an equivalent volume as the particle. In some embodiments in which the MOF particles have non-spherical shapes, the particle size refer may to the diameter of a sphere having an equivalent diffusion coefficient as the particle.

In some embodiments, the MOF particles of the present disclosure are monodisperse, having a coefficient of variation or relative standard deviation, expressed as a percentage and defined as the ratio of the particle size standard deviation (o) to the particle size mean (u) multiplied by 100 of less than 25%, preferably less than 10%, preferably less than 8%, preferably less than 6%, preferably less than 5%, preferably less than 4%, preferably less than 3%, preferably less than 2%. In some embodiments, the MOF particles of the present disclosure are monodisperse having a particle size distribution ranging from 80% of the average particle size to 120% of the average particle size, preferably 90-110%, preferably 95-105% of the average particle size. In some embodiments, the $$ are not monodisperse.

In general, the particle size may be determined by any suitable method known to one of ordinary skill in the art. In some embodiments, the particle size is determined by powder X-ray diffraction (PXRD). Using PXRD, the particle size may be determined using the Scherrer equation, which relates the full-width at half-maximum (FWHM) of diffraction peaks to the size of regions comprised of a single crystalline domain (known as crystallites) in the sample. In some embodiments, the crystallite size is the same as the particle size. For accurate particle size measurement by PXRD, the particles should be crystalline, comprise only a single crystal, and lack non-crystalline portions. Typically, the crystallite size underestimates particle size compared to other measures due to factors such as amorphous regions of particles, the inclusion of non-crystalline material on the surface of particles such as bulky surface ligands, and particles which may be composed of multiple crystalline domains. In some embodiments, the particle size is determined by dynamic light scattering (DLS). DLS is a technique which uses the time-dependent fluctuations in light scattered by particles in suspension or solution in a solvent, typically water to measure a size distribution of the particles. Due to the details of the DLS setup, the technique measures a hydrodynamic diameter of the particles, which is the diameter of a sphere with an equivalent diffusion coefficient as the particles. The hydrodynamic diameter may include factors not accounted for by other methods such as non-crystalline material on the surface of particles such as bulky surface ligands, amorphous regions of particles, and surface ligand-solvent interactions. Further, the hydrodynamic diameter may not accurately account for non-spherical particle shapes. DLS does have an advantage of being able to account for or more accurately model solution or suspension behavior of the particles compared to other techniques. In some embodiments, the particle size is determined by electron microscopy techniques such as scanning electron microscopy (SEM) or transmission electron microscopy (TEM).

In some embodiments, the MOF is dispersed into the polymer matrix. In some embodiments, the MOF is present in about 0.01 to 5 wt. %, preferably 0.05 to 2.5 wt. %, preferably 0.1 to 2 wt. %, preferably 0.2 to 1.75 wt. %, preferably 0.25 to 1.25 wt. %, preferably 0.25 to 1 wt. % based on the total weight of the fire-retardant material. In some embodiments, the nature of the interaction between the polymer matrix and the MOF involves hydrogen bonding. For example, the hydroxy functional groups of the MOF may be hydrogen bonded to carboxyl, amino, or hydroxyl functional groups present in the polymer matrix.

### Properties of Fire-Retardant Material

Water swelling percentage is a parameter that provides insight into the material's characteristics and helps determine if the material is durable in moist environments. Polyurethanes may be characterized by a water swelling percentage. The water swelling percentage measures how much a material, such as the fire-retardant material of the present disclosure, can expand when it is exposed to water. A high water swelling can lead to deformation, weakening, or deterioration of the materials over time. In some embodiments, the fire-retardant material of the present disclosure has fewer polar groups than the pristine polyurethane- and hence lower water swelling percentage compared to a pristine polyurethane (e.g., one which does not contain for example, the MOF and/or the organophosphorus-containing polyol). A pristine polyurethane typically has a water swelling percentage of about 12 to 13%. In some embodiments, the fire-retardant material of the present disclosure exhibits a water swelling percentage in the range of 5 to 9%, preferably 5.1 to 8%. In some embodiments, the fire-retardant material has a water swelling percentage of about 5.1%, 5.25% 5.5%, 5.75%, 6.0%, 6.25%, 6.5%, 6.75%, 6.8%, 7.0%, 7.25%, 7.4%, 7.5%, 7.75%, or 8.0%.

Water contact angle (WCA) is a parameter that provides insight into whether a material is hydrophilic or hydrophobic. In some embodiments, the WCA of the fire-retardant material is about 70 to 100°, preferably 75 to 91°. In some embodiments, the fire-retardant material has a WCA of 72.5°, 75°, 77.5°, 80°, 82.5°, 85°, 87.5°, 90°, 92.5°, 95°, or 97.5°. A typical pristine polyurethane may have a WCA of about 64 to 65°, which is much lower than the fire-retardant material of the present disclosure. This difference in the WCA may be indicative of the hydrophobic nature of the fire-retardant material. The higher WCA may indicate that the fire-retardant material has a higher resistance to degradation in the presence of moisture. This may be advantageous for using the fire-retardant material of the present disclosure in environments with high humidity or rain.

Shore A hardness is a measure of the hardness of a material. Shore A harness is measured on a scale of 0-100, where lower values are generally observed for softer materials. In comparison, higher values are observed for harder materials. In some embodiments, the Shore A hardness of the fire-retardant material is about 70 to 85, preferably 72 to 83. A typical pristine polyurethane may have a Shore A hardness in the range of 64 to 68, which is much lower than the fire-retardant material of the present disclosure. In some embodiments, the Shore A hardness of the fire-retardant material may be about 71, 72, 73, 74, 75, 76, 77, 78, 79, 80, 81, 82, 83, 84, or 85.

Fire-retardant materials must withstand mechanical stresses (stiffness, strength and durability) while also providing enhanced fire safety. The ability of the fire-retardant material to withstand mechanical stresses may be measured by properties such as tensile strength and Young's modulus. In some embodiments, fire-retardant material has a tensile strength of 22.5 to 29.5 MPa, preferably 24-27 MPa. For example, the fire-retardant material may have a tensile strength of 23 MPa, 23.5 MPa, 24 MPa, 24.5 MPa, 25 MPa, 26.5 MPa, 27 MPa, 27.5 MPa, 28 MPa, 28.5 MPa, or 29 MPa. Typically, a pristine polyurethane has a tensile strength of about 18-21 MPa, lower than the fire-retardant material of the present application. In some embodiments, fire-retardant material has a Young's modulus of about 3 to 10 MPa. For example, the fire-retardant material may have a Young's modulus of about 3.5 MPa, 4 MPa, 4.5 MPa, 5 MPa, 5.5 MPa, 6 MPa, 6.5 MPa, 7 MPa, 7.5 MPa, 8 MPa, 8.5 MPa, 9 MPa, or 9.5 MPa. Typically, a pristine polyurethane has a Young's modulus of about 3 to 5 MPa, lower than the fire-retardant material of the present application.

The Limiting Oxygen Index (LOI) is a test used to evaluate the flammability of the fire-retardant material. LOI is a measure of the minimum concentration of oxygen, expressed as a percentage, required for the fire-retardant material to sustain combustion. A higher LOI value indicates that the material is less flammable, as it needs a higher oxygen concentration to continue burning. In some embodiments, the fire-retardant material of the present disclosure has a LOI of 22.5 to 35. For example, the fire-retardant material may have a LOI of about 23.0, 23.25, 23.5, 23.75, 24.0, 24.25, 24.5 24.75, 25.0, 25.25, 25.5, 25.75, 26.0, 26.25, 26.5, 26.75, 27.0, 27.25, 27.5, 27.75, 28.0, 28.25, 28.5, 28.75, 29.0, 29.25, 29.5, 29.75, 30.0, 30.25, 30.5, 30.75, 31.0, 31.25, 31.5, 31.75, 32.0, 32.25, 32.5, 32.75, 33.0, 33.5, 34.0, or 34.5. Typically, a pristine polyurethane has a LOI of about 17-18, lower than the fire-retardant material of the present application.

Residue char is another parameter that provides information on the effectiveness of the fire-retardant material. When the fire-retardant material is exposed to high temperatures, the residue char left formed on the surface of the fire-retardant material impedes the passage of volatile gases, effectively insulating the surrounding environment from heat and thereby enhancing fire safety. In some embodiments, the residue char of the pristine polyurethane is in the range of about 7.5 to 15 wt. %, preferably 8.6 to 13.7 wt. % based on an initial weight of fire-retardant material. Typically, a pristine polyurethane has a residue char of about 1-4 wt. %, significantly lower than the fire-retardant material of the present application.

### Method of Synthesizing Fire-Retardant Material

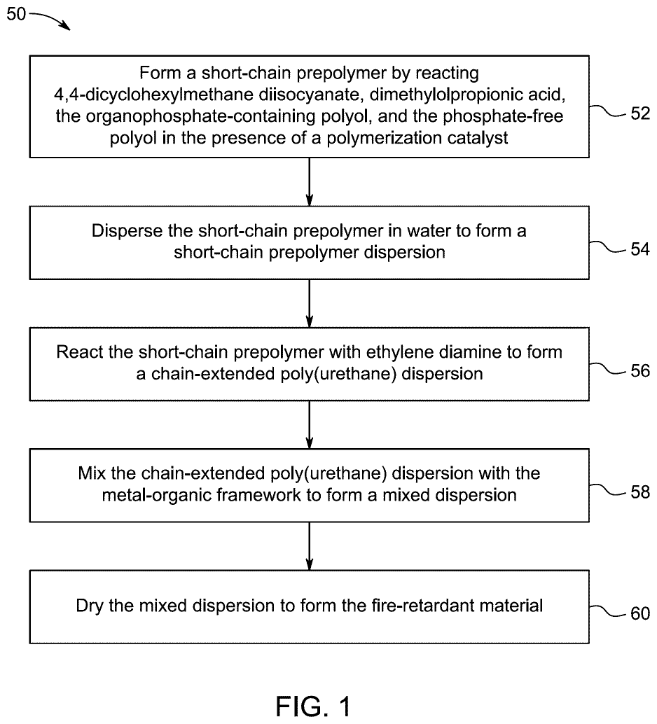

FIG. 1 illustrates a schematic flow chart of a method 50 of synthesizing the fire-retardant material. The order in which the method 50 is described is not intended to be construed as a limitation, and any number of the described method steps can be combined to implement the method 50. Additionally, individual steps may be removed or skipped from the method 50 without departing from the spirit and scope of the present disclosure.

At method 52, the method 50 includes forming a short-chain prepolymer by the diisocyanate, the carboxylate-comprising organic diol, the organophosphorus-containing polyol, and the organophosphorus-free polyol in the presence of a polymerization catalyst. In some embodiments, the method 50 includes reacting 4,4-dicyclohexylmethane diisocyanate, dimethylolpropionic acid, the organophosphorus-containing polyol, and the organophosphorus-free polyol in the presence of a polymerization catalyst.

In some embodiments, this reaction is catalyzed by a polymerization catalyst. Suitable examples of polymerization catalysts include, but are not limited to, amine catalysts such as tertiary amine compounds including triethylenediamine, N-methylmorpholine, N,N-dimethylcyclohexylamine, pentamethyldiethylenetriamine, tetramethylethylenediamine, bis (dimethylaminoethyl) ether, 1-methyl-4-dimethylaminoethylpiperazine, 3-methoxy-N-dimethylpropylamine, N-ethylmorpholine, dimethylethanolamine, N-cocomorpholine, N,N-dimethyl-N′,N′-dimethyl isopropylpropylenediamine, N,N-diethyl-3-diethylaminopropyl amine and dimethylbenzylamine; and organometallic catalysts such as organomercury, organolead, organoferric, and organotin catalysts. Examples of tin catalysts include stannous chloride, tin salts of carboxylic acids such as dibutyltin di-laurate. In some embodiments, the polymerization catalyst is dibutyltin di-laurate. In some embodiments, weight percentage of the polymerization catalyst in the reaction mixture is in the range of 0.01-0.1%, preferably about 0.01%.

In general, the reaction may be preferably performed in a reactor, such as a glass or stainless-steel reactor. In some embodiments, the reaction may be performed in a controlled atmosphere. The use of a controlled atmosphere may be advantageous to prevent any unwarranted side reactions. In some embodiments, the reaction is carried out in an inert atmosphere. In general, an inert atmosphere may be provided by either a vacuum or by an inert gas such as nitrogen, helium, argon, neon, or other suitable inert gas or mixture thereof. The inert atmosphere may be static or may have a flow of one or more gases. In some embodiments, the inert atmosphere is provided by nitrogen. In some embodiments, the reactor may be purged with nitrogen before performing the reaction.

The polymerization reaction is preferably carried out at a temperature range of about 70 to 100° C., preferably 80 to 90° C., preferably at about 85° C. for 1 to 5 hours, preferably 2 to 4 hours, preferably 3 hours to form the short-chain prepolymer. In some embodiments, the polymerization catalyst may be removed once the reaction is complete.

In some embodiments, the viscosity of the reaction mixture increases as the short-chain prepolymer is formed in the reactor. To avoid problems with high viscosity, it may be advantageous to stir the reaction mixture during the reaction. In some embodiments, a suitable solvent, preferably methyl ethyl ketone (“MEK”), can be added to the reaction mixture. The solvent reduces the viscosity of the reaction mixture by dissolving the short-chain prepolymer and thereby decreasing its thickness. The weight percentage of MEK is about 1-10 wt. %, preferably 2-8 wt. %, preferably 4-6 wt. %, preferably about 5 wt. %. In some embodiments, solvents such as toluene, ethyl acetate, acetone, and the like can also be used instead of or in addition to MEK.

In some embodiments, the short-chain prepolymer may be neutralized using an amine. Examples of suitable amines include, but are not limited to ammonia, methylamine, ethylamine, n-propylamine, isopropylamine, dimethylamine, diethylamine, di-n-propylamine, di-isopropylamine, trimethylamine, triethylamine, tri-n-propylamine, and tri-isopropylamine. This neutralization may be advantageous for removing any unreacted diisocyanates. The neutralization may be advantageous for increasing the stability of the short-chain prepolymer before proceeding to the next steps.

At step 54, the method 50 includes dispersing the short-chain prepolymer in water to form a short-chain prepolymer dispersion. In some embodiments, the short-chain prepolymer dispersion may be subjected to stirring and/or sonication. Such stirring and/or sonication can be advantageous to ensure complete and/or uniform dispersion of the short-chain prepolymer in water.

At step 56, the method 50 includes chain extending the short-chain prepolymer by reacting the short-chain prepolymer with the chain extender to form a chain-extended poly(urethane) dispersion. In some embodiments, the chain extender is ethylene diamine. In some embodiments, this reaction is performed at a chain extension temperature of 25 to 60° C., preferably at 25° C. for 30 minutes or at 40° C. for 2 hours. In some embodiments, the reaction temperature and time may be adjusted beyond the suggested ranges.

In some embodiments, the chain-extended poly(urethane) dispersion has a solid content of 20 to 45 wt. %, preferably about 22 to 42 wt. %, preferably 24 to 40 wt. %, preferably 26 to 35 wt. %, preferably 29 to 31 wt. % based on the total weight of chain-extended poly(urethane) dispersion.

At step 58, the method 50 includes mixing the chain-extended poly(urethane) dispersion with the metal-organic framework to form a mixed dispersion. In some embodiments, the metal-organic framework includes about 0.01 to 5 wt. %, preferably 0.05 to 2.5 wt. %, preferably 0.1 to 2 wt. %, preferably 0.2 to 1.75 wt. %, preferably 0.25 to 1.25 wt. %, preferably 0.25 to 1 wt. % relative to the chain-extended poly(urethane) dispersion. In some embodiments, the chain-extended poly(urethane) dispersion is sonicated with the metal-organic framework for 30 minutes to 3 hours, preferably 1 to 2 hours, preferably 1 hour. In some embodiments, the chain-extended poly(urethane) dispersion is further subjected to stirring for 12 to 36 hours, preferably for about 24 hours. The sonication and/or stirring may be advantageous to ensure that the mixed dispersion is homogenous and uniform.

At step 60, the method 50 includes drying the mixed dispersion to form the fire-retardant material. The fire-retardant material may be optionally cured/molded into any desired shape and/or applied as a coating to a surface of a material.

### Method of Passivating a Surface

The present disclosure also relates to a method of passivating a surface against hydrogen embrittlement. In some embodiments, the surface is a metal surface. In general, the metal surface may include one or more metals. Examples of suitable metals include, but are not limited to, from copper, copper alloys (e.g. brass or bronze), aluminum, aluminum alloys (e.g. aluminum-magnesium, nickel-aluminum, aluminum-silicon), nickel, nickel alloys (e.g. nickel-titanium or nickel-chromium), iron, iron alloys, carbon steels, alloy steels, duplex stainless steels, and tool steels. In some embodiments, the metal surface includes one or more of steel, carbon steel, low carbon steel, mild steel, medium carbon steel, high carbon steel, alloy steel, stainless steel, austenitic steel, ferritic steel, martensitic steel, tool steel, or mixtures thereof. In some embodiments, the surface is a metal surface, and the metal surface includes mild steel. An exemplary mild steel has an elemental that includes about 0.6% of manganese, 0.01 to 0.15% of carbon, 0.01 to 0.03% phosphorus, and 0.01 to 0.035% sulfur.

In some embodiments, the surface, such as a metal surface, may be a part of a casing—for example, a well casing, a pipe—for example, transport pipelines, a pump, a screen, a valve, a fitting of an oil or gas well, drilling and other oil field applications, transport, separation, refining, storage, and other liquid natural gas and petroleum-related applications, geothermal wells, water wells; cooling water systems including open recirculating, closed, and once-through systems; cisterns and water collection or holding systems, solar water heating systems, boilers and boiler water systems or systems used in power generation, mineral process waters including mineral washing, flotation and benefaction; paper mill digesters, washers, bleach plants, white water systems and mill water systems; black liquor evaporators in the pulp industry; gas scrubbers and air washers; continuous casting processes in the metallurgical industry; air conditioning and refrigeration systems; building fire protection heating water, such as pasteurization water; water reclamation and purification systems; membrane filtration water systems; food processing streams and waste treatment systems as well as in clarifiers, liquid-solid applications, municipal sewage treatment systems; and industrial or municipal water distribution systems. In some embodiments, the metal surface may be used in the drilling, petroleum, oil, and gas industries, including drills, drill bits, pumps, compressors, pipelines, and other tools and equipment, electric parts such as transformers, power generators, and electric motors, vehicle parts including those of boats, autos, trucks, aircraft, and military vehicles. Tools, including construction, automotive, household, and kitchen tools, are included.

In some embodiments, the method includes applying the fire-retardant material to the surface. The fire-retardant material can be applied using a suitable applicator or other implement and/or by any suitable method known to a person skilled in the art. In some embodiments, the fire-retardant material is uniformly applied as a coating on at least a portion of the metal surface. In some embodiments, the thickness of the coating is in the range of 25 to 500 μm, preferably 30 to 490 μm, preferably 35 to 480 μm, preferably 40 to 470 μm, preferably 45 to 460 μm, preferably 50 to 450 μm. For example, the thickness of the coating can be 55 μm, 60 μm, 65 μm, 70 μm, 75 μm, 80 μm, 85 μm, 90 μm, 95 μm, 100 μm, 105 μm, 110 μm, 115 μm, 120 μm, 125 μm, 130 μm, 135 μm, 140 μm, 145 μm, 150 μm, 155 μm, 160 μm, 165 μm, 170 μm, 175 μm, 180 μm, 185 μm, 190 μm, 195 μm, 200 μm, 210 μm, 220 μm, 230 μm, 240 μm, 250 μm, 260 μm, 270 μm, 280 μm, 290 μm, 300 μm, 310 μm, 320 μm, 330 μm, 340 μm, 350 μm, 360 μm, 370 μm, 380 μm, 390 μm, 400 μm, 410 μm, 420 μm, 430 μm, 440 μm, 450 μm, 460 μm, 470 μm, 480 μm, 490 μm, or 500 μm. In some embodiments, the fire-retardant material is stable and shows no detectable change in FTIR peak positions after exposure to a gas mixture including 1% to 90% hydrogen for 1 to 96 hours, compared to FTIR peak positions of the fire-retardant material before the exposure. The gas mixture can include, for example, 1%, 2%, 3%, 4%, 5%, 6%, 7%, 8%, 9%, 10%, 11%, 12.5%, 15%, 17.5%, 20%, 22.5% 25%, 27.5%, 30%, 35%, 40%, 45%, 50%, 55%, 60%, 65%, 70%, 75%, 80%, 85%, or 90% hydrogen.

### EXAMPLES

The following examples demonstrate an exemplary fire-retardant material, according to certain embodiments of the present disclosure. The examples are provided solely for illustration and are not to be construed as limitations of the present disclosure, as many variations thereof are possible without departing from the spirit and scope of the present disclosure.

### Example 1: Materials

Chemicals were provided by Sigma Aldrich, including 4,4-dicyclohexylmethane diisocyanate (H₁₂MDI), triethylamine (TEA), ethylene diamine (EDA), poly(tetramethylene oxide glycol) (PTMG, Mn=2000), dimethylolpropionic acid (DMPA), methyl ethyl ketone (MEK), and dibutyltindilaurate (DBTDL). PTMG was vacuum-dried at 90° C. for three hours before use.

### Example 2: Preparation of the Fire-Retardant Material

Pristine PU dispersions were prepared to achieve a long shelf-life dispersion with protective properties. In the next step, the long shelf-life dispersion formulation was modified with phosphol polyol to enhance fire retardancy. Finally, MOF particles were incorporated into the PU formulation to further improve fire retardancy and reduce gas and water diffusion. The pristine PU dispersion was prepared with fixed monomer contents of polyether polyol (0.310 mol), while the chain extender (0.180 mol) and diisocyanate (1.0 mol) contents were increased to impart a stiffer character to the coating. The base monomers and their contents are summarized in Tables 1, 2, and 3, below.

TABLE 1
Formulation of pristine PU coating.

| | Composition (Mol) | | | | | DMPA |
|---|---|---|---|---|---|---|
| Coating | PTMG | DMPA | TEA | EDA | H₁₂MDI | (mol %) |
| PU 1 | 1.25 | 1.45 | 1.45 | 1.30 | 4.00 | 18.13 |
| PU2 | 1.25 | 1.65 | 1.65 | 1.10 | 4.00 | 20.63 |
| PU3 | 1.25 | 1.85 | 1.85 | 0.90 | 4.00 | 23.13 |
| PU4 | 1.25 | 2.05 | 2.05 | 0.70 | 4.00 | 25.63 |
| PU5 | 1.25 | 2.25 | 2.25 | 0.50 | 4.00 | 28.13 |

TABLE 2
Formulation of coating with defined phospol content.

| | Composition (Mol) | | | | | | |
|---|---|---|---|---|---|---|---|
| | Polyol | | | | | | Phospol |
| Coating | PTMG | Phospol | DMPA | TEA | EDA | H₁₂MDI | (mol %) |
| PU4 | 1.25 | 0 | 2.05 | 2.05 | 0.70 | 4.00 | 0 |
| PU4/ | 1.15 | 0.10 | 2.05 | 2.05 | 0.70 | 4.00 | 1.25 |
| PP1 | | | | | | | |
| PU4/ | 1.05 | 0.20 | 2.05 | 2.05 | 0.70 | 4.00 | 2.50 |
| PP2 | | | | | | | |
| PU4/ | 0.95 | 0.30 | 2.05 | 2.05 | 0.70 | 4.00 | 3.75 |
| PP3 | | | | | | | |
| PU4/ | 0.85 | 0.40 | 2.05 | 2.05 | 0.70 | 4.00 | 5.00 |
| PP4 | | | | | | | |

TABLE 3
Formulation of coating with defined MOF content.

| | Composition (Mol) | | | | | | |
|---|---|---|---|---|---|---|---|
| | Polyol | | | | | | MOF |
| Coating | PTMG | Phospol | DMPA | TEA | EDA | H₁₂MDI | (mol %) |
| PU4/ | 0.85 | 0.40 | 2.05 | 2.05 | 0.70 | 4.00 | 0.10 |
| PP3- | | | | | | | |
| MOF1 | | | | | | | |
| PU4/ | 0.85 | 0.40 | 2.05 | 2.05 | 0.70 | 4.00 | 0.25 |
| PP3- | | | | | | | |
| MOF2 | | | | | | | |
| PU4/ | 0.85 | 0.40 | 2.05 | 2.05 | 0.70 | 4.00 | 0.50 |
| PP3- | | | | | | | |
| MOF3 | | | | | | | |
| PU4/ | 0.85 | 0.40 | 2.05 | 2.05 | 0.70 | 4.00 | 1.00 |
| PP3- | | | | | | | |
| MOF4 | | | | | | | |

The potential changes in the structure and properties of the coating in a hydrogen environment, as well as the protective properties of coatings for the external applications of pipelines, were evaluated. The coating's barrier resistance, flame retardancy, adhesive strength, and corrosion resistance all increased with the rising content of chain extender and diisocyanate. HDPE liners and mild steel were used as substrates for the coatings during hydrogen exposure. Defined concentrations of methane and hydrogen blended gases were utilized under artificial gas exposure conditions.

The PU coating retained its chemical composition, and the crystallinity was only very slightly affected. However, some coatings exhibited delamination. The coatings were also exposed outdoors for six months. The hydrophobicity and fire retardancy of the exposed coatings were maintained at nearly the same values, confirming their stable external protective properties.

### Example 3: Waterborne Polyurethane (PU) Dispersion Preparation

The PU dispersion was prepared using a two-stage process, where an NCO-terminated pre-polymer was synthesized initially. A nitrogen atmosphere was maintained throughout the reactions. The pre-polymers were prepared by charging H12MDI, DMPA, and PTMG. To accelerate the reaction, the catalyst DBTDL (0.01 wt. %) was added. To manage the viscosity of the reaction mixture, MEK (5.0 wt. %) was also included. The reaction was conducted for three hours at 85° C. Subsequently, neutralization (TEA addition), dispersion (H₂O), and chain extension (EDA mixed with H₂O) were carried out at 65° C. (30 min), 25° C. (30 min), and 40° C. (2 h), respectively. The solid content of the dispersions was determined to be 29.0-30.5 wt. %.

### Example 4: Phospholipid-Based Waterborne Polyurethane (PU/PP) Dispersion Preparation

The steps followed were similar to those for pristine PU dispersion preparation above, with the addition of the phospholipid monomer alongside PTMG before adding DMPA. The solid content of these dispersions was found to be 29.2-30.4 wt. %.

### Example 5: MOF Preparation

The Zr-MOF was prepared according to the method reported by Moghaddam et al. (2018) [Moghaddam, Z. S., et al., Spectrochimica Acta Part A, 2018 194, 76-82, incorporated herein by reference in its entirety].

### Example 6: PU/MOF Dispersion Preparation

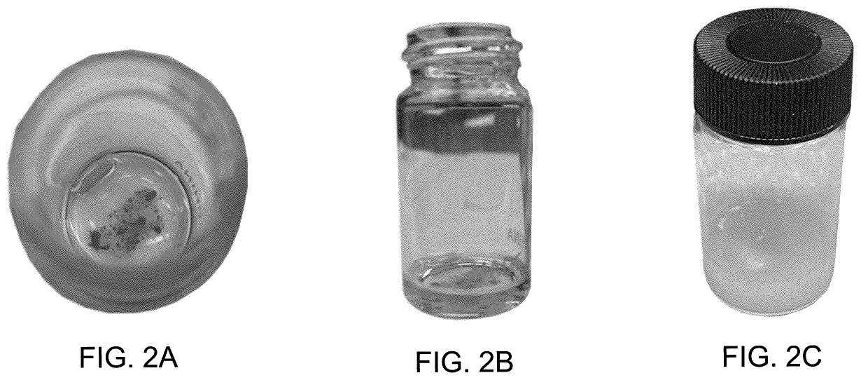

The PU/MOF dispersion was prepared using a simple blending process as depicted in FIGS. 2A-2B before stirring and FIG. 2C after stirring. A defined MOF content (0.25, 0.50, 0.75, 1.00, and 1.25 wt. %) was mixed with the PU dispersion and stirred both mechanically and ultrasonically. A specific amount of PU dispersion was weighed in a vial, and the MOF was added to that dispersion. The mixture was then subjected to mechanical stirring for one hour at room temperature. Although most of the MOF particles mixed with the dispersion, this mixture was not homogeneous. Consequently, the dispersion was ultrasonicated (60 sonics/min, room temperature) for one hour and stirred mechanically for an additional 24 hours, resulting in a homogeneous dispersion. This process was consistent across different MOF contents. A homogeneous dispersion was achieved with a maximum of 1.0 wt. % MOF content, and the dispersion remained free of precipitation for one week. The PU/MOF dispersion exhibited high viscosity after 72 hours, and when the MOF content exceeded 1.0 wt. %, the dispersion was not homogeneous. Four dispersions with 0.25, 0.50, 0.75, and 1.00 wt. % MOF were used for characterization. The polyurethane solution (2.0150 grams) was mixed with four different nanoparticle contents (0.0063, 0.0137, 0.0206, and 0.0268 grams).

### Example 7: Preparation of Polymer Film

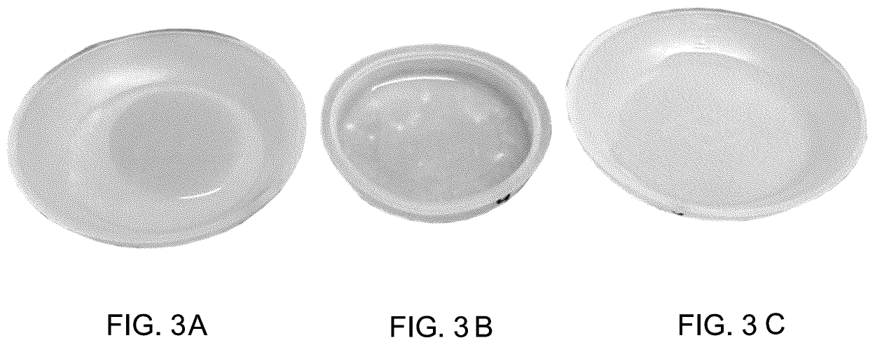

A specific amount of dispersion was transferred into a Teflon disk, as shown in FIGS. 3A-3C. The dispersion was completely dried within 50 hours and then further dried at 60° C. for 12 hours under vacuum to remove all solvent.

### Example 8: Coating on Metal Sheet

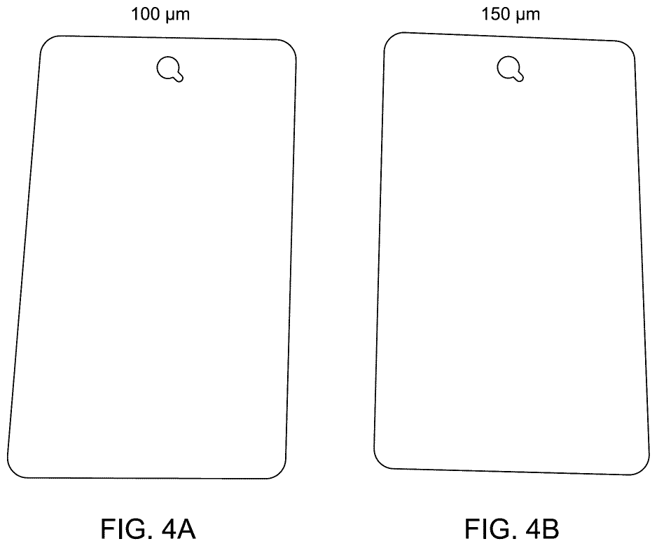

An applicator was used to coat the metal sheet (S-36 mild steel Q-panels, dimensions: 3× 6×0.032 inches; chemical composition: max 0.60% Manganese, max 0.15% Carbon, max 0.030% Phosphorus, max 0.035% Sulfur). Defined wet coatings of 50, 100, 150, and 200 μm were prepared, as illustrated in FIG. 4. The coatings were allowed to dry adequately before testing.

### Example 9: Characterization

The typical functional groups of the PU were identified by Fourier transform infrared spectroscopy (FT-IR) (Impact 400D, Nicolet, 32 scans at a resolution of 4 cm⁻¹). The hydrogen bonding of the films was also analyzed using FT-IR. Swelling tests (%) were conducted in water by immersing the respective film for a defined time at a specific temperature (48 hours at 30° C.). The swelling was determined using equation (1):

$$Swelling ( \% ) = [ ( W - {W}_{0} ) / {W}_{0} ) ] \times 100$$

Where W is the weight of the film at equilibrium swelling, and W₀ is the weight of the dried film.

Film hardness was measured using the Shore A hardness test according to ASTM D2240-75 specifications, employing the LX-A Rubber Hardness Tester (Shanghai Liuling Instrument Company, Shanghai, China). The reported results are averages of five tests.

Thermal gravimetry analysis (TGA) was performed using a Pyris 6 TGA (Perkin Elmer, USA), with heating from 30 to 500° C. at a rate of 10° C./min.

### Example 10: Dispersion Stability

The stability and shelf life of the PU dispersion primarily depend on the DMPA/TEA content, which is consistently maintained at the same ratio. A DMPA/TEA content above 12.0 mole % typically results in a stable dispersion, with shelf life increasing at higher DMPA/TEA levels. In the first series of PU dispersions, varying DMPA/TEA contents were tested, and the maximum shelf life was recorded with 25.63 mol % DMPA content (referred to as PU4). This dispersion remained stable for over one year. Based on the PU4 formulation, phospholipid was added to the PU dispersion (see Table 2). With other monomer contents fixed, the phospholipid content was adjusted, which did not significantly affect dispersion stability. All dispersions remained stable for one year. The PU4/PP3 dispersion was selected for the addition of MOF. Various defined MOF contents were incorporated without compromising the stability and shelf life of the PU dispersion.

Although the MOF-based polymer nanocomposite demonstrated promising results, its practical application remains limited. The primary challenge with MOF-based polymer nanocomposites is achieving a homogeneous dispersion. Unstable dispersions are common in various solvent media and polymer matrices, as MOF nanoparticles tend to agglomerate easily in both dispersions and films. This agglomeration negatively affects performance. Therefore, it is crucial to prevent such agglomeration in both the dispersion and solid stages. It is well-established that the stability of dispersions is influenced by phase separation. Unstable dispersions may transition into gels, exhibit segmentation (precipitation) immediately after preparation, or undergo phase separation within a few days. A minimum DMPA content is generally required for the formation of stable waterborne polyurethane (WBPU) dispersions, with stability and shelf life increasing at higher DMPA levels. A higher DMPA content was utilized to create a stable dispersion, resulting in dispersions that remained stable for over 12 months, free from agglomeration and precipitation in both films and coatings. It has been shown that positive and negative ion particles can create an electrostatic double layer, enhancing the stability of WBPU dispersions. The MOF used in this study contains hydroxyl groups, which may contribute to maintaining this layer, thereby ensuring that the dispersion stability and shelf life remained consistent across all formulations. The surface structure of the MOF is particularly important for achieving a stable dispersion, and by modifying the functional groups, the stability of the WBPU/MOF dispersion can be enhanced.

### Example 11: FT-IR Spectroscopy

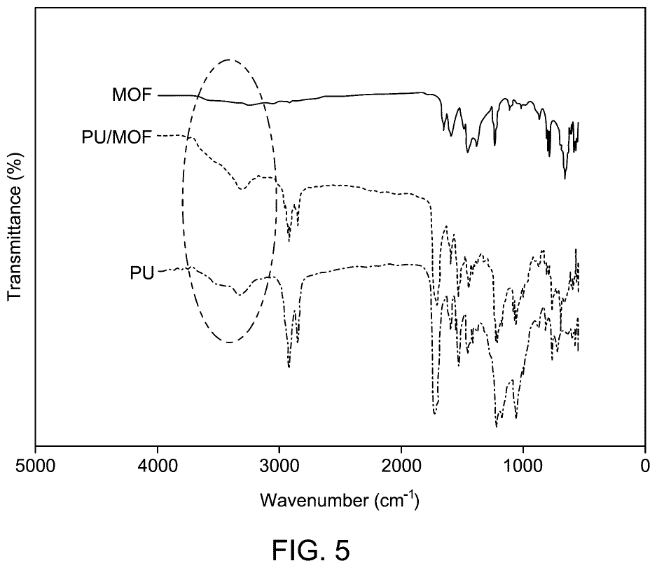

FT-IR spectroscopy was employed to identify the respective functional groups within the polymers. The typical spectra are presented in FIG. 5. Peaks corresponding to specific functional groups confirmed the successful preparation of polyurethane across all three series. Bands were recorded at 2919, 1624, 1247, 1144, and 1001 cm⁻¹ for —C—H, —C═C, —C—N, —C—O—C, and —C═O groups, respectively. These peaks primarily arise from urethane and urea groups. Notably, the peaks were of similar intensity, although slight shifts were observed for the carbonyl (C═O) peak at 1704 cm⁻¹ and the amine (N—H) peak at 3340 cm⁻¹ with 1.0 wt. % MOF content. The shift to lower values indicates the formation of hydrogen bonds, involving the free hydroxyl groups of the MOF.

### Example 13: Water Swelling and Water Contact Angle

Water swelling percentage was measured to evaluate the coating's diffusion properties. Polyurethane (PU) is a widely utilized engineering polymer, employed in various industrial applications, including coatings, adhesives, leather, and composites. However, due to the presence of polar groups such as secondary amines, carbonyls, and urethanes on the crosslinked structure, PU exhibits poor moisture barrier properties. These functional groups interact with water molecules, facilitating permeation and leading to degradation of the material's characteristics. A water swelling test was performed to estimate the degree of swelling, providing insight into barrier and diffusion characteristics. The results are summarized in Table 4. The pristine PU coatings are predominantly hydrophilic, indicating ease of diffusion; this value increased slightly after phospholipid addition, suggesting a minimal improvement in diffusion resistance. However, a significant reduction in swelling percentage was observed with the addition of MOF, resulting in the lowest swelling percentage for the PU coating with the highest MOF content. Specifically, the water swelling percentage for the PU4/PP4-MOF4 coating decreased from 12.20% to 4.10%.

Wettability was quantitatively evaluated using water contact angle measurements (WCA). Approximately 3 μL of distilled water was deposited onto each sample using an optical sessile drop system, and a sophisticated digital camera captured the water droplets on the coatings. The respective values are summarized in Table 4.

TABLE 4
Properties of coatings.

| | | Water | | | | | | | | |
|---|---|---|---|---|---|---|---|---|---|---|
| | Water | contact | | Tensile | Young's | Elongation | | | Residue Char | |
| | swelling | angle | Hardness | strength | modulus | at break | LOI (%) | | (wt. %) | |
| Coating | (%) | (°) | (Shore A) | (MPa) | (MPa) | (%) | Unexposed | Exposed | Unexposed | Exposed |
| PU1 | 12.2 | 64 | 68 | 21 | 5 | 1002 | 17.1 | 8.5 | 2.6 | 1.8 |
| PU2 | 12.3 | 64 | 67 | 20 | 5 | 1010 | 17.4 | 8.2 | 2.8 | 1.7 |
| PU3 | 12.7 | 66 | 65 | 18 | 4 | 1035 | 17.7 | 8.3 | 3.0 | 1.6 |
| PU4 | 12.9 | 65 | 64 | 18 | 3 | 1051 | 17.6 | 8.3 | 3.1 | 1.7 |
| PU4/ | 12.4 | 66 | 64 | 19 | 3 | 1047 | 18.8 | 10.1 | 3.5 | 2.4 |
| PP-1 | | | | | | | | | | |
| PU4/ | 10.8 | 68 | 65 | 20 | 3 | 1025 | 20.7 | 11.1 | 4.3 | 2.9 |
| PP-2 | | | | | | | | | | |
| PU4/ | 9.7 | 71 | 67 | 22 | 4 | 995 | 22.1 | 12.2 | 6.8 | 3.2 |
| PP-3 | | | | | | | | | | |
| PU4/ | 8.2 | 74 | 70 | 24 | 5 | 987 | 24.3 | 13.3 | 8.4 | 3.9 |
| PP-4 | | | | | | | | | | |
| PU4/ | 8.0 | 75 | 72 | 24 | 5 | 985 | 24.6 | 20.2 | 8.6 | 6.9 |
| PP4- | | | | | | | | | | |
| MOF1 | | | | | | | | | | |
| PU4/ | 7.4 | 79 | 75 | 25 | 6 | 977 | 25.8 | 21.5 | 9.2 | 7.4 |
| PP4- | | | | | | | | | | |
| MOF2 | | | | | | | | | | |
| PU4/ | 6.8 | 85 | 79 | 26 | 7 | 969 | 27.2 | 24.6 | 10.8 | 9.5 |
| PP4- | | | | | | | | | | |
| MOF3 | | | | | | | | | | |
| PU4/ | 5.1 | 91 | 83 | 27 | 8 | 955 | 30.1 | 29.6 | 13.7 | 12.9 |
| PP4- | | | | | | | | | | |
| MOF4 | | | | | | | | | | |

The stability and shelf life of the PU dispersion primarily depend on the DMPA/TEA content, which is consistently maintained at the same ratio. A DMPA/TEA content above 12.0 mole % typically results in a stable dispersion, with longer shelf life observed at higher DMPA/TEA levels. In the initial series of PU dispersions, varying DMPA/TEA contents were used, and the maximum shelf life was recorded with 25.63 mol % DMPA content (referred to as PU4). This dispersion remained stable for over one year. Based on the PU4 formulation, phosphol was added to the PU dispersion (see Table 2). With other monomer contents fixed, the phosphol content was adjusted, and the stability of the dispersions remained largely unaffected. All dispersions also demonstrated stability for one year. The PU4/PP3 dispersion was selected for MOF addition, with different defined MOF contents incorporated without compromising the stability and shelf life of the PU dispersion.

The water contact angle (WCA) test indicates a positive correlation, where an increase in Metal-Organic Framework (MOF) content corresponds to a rise in the contact angle. However, this trend is not observed in the PU/M-1 formulation, likely due to the relatively low concentration of MOF particles. Moreover, the increase in WCA from PU4/PP4-MOF2 to PU4/PP4-MOF4 is associated with changes in polarity resulting from the addition of higher MOF contents. Consequently, hydrophobicity increases, with the highest value recorded for PU4/PP4-MOF4, which contains the highest MOF content. Although fully hydrophilic behavior was not achieved, the results are promising. Generally, the wettability of the samples decreases as MOF content increases. The pristine PU coating showed only marginal changes in values with varying DMPA/TEA and EDA contents. The slight increase in value with the addition of PP also suggests an improvement in hydrophobicity.

### Example 14: Thermal Properties

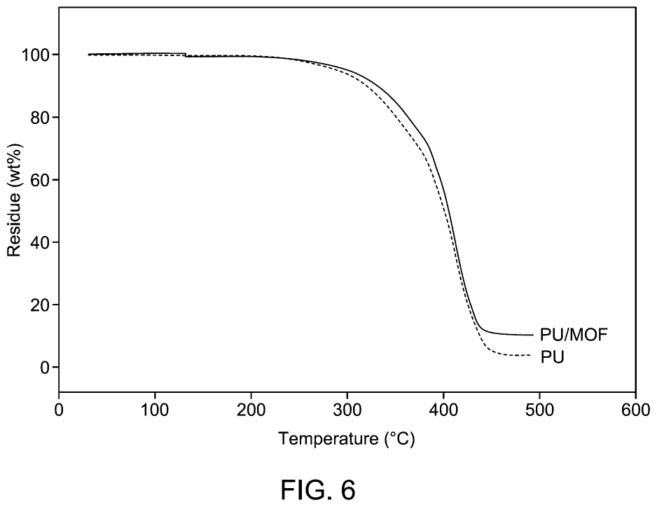

The widely used TGA method was employed to evaluate the thermal resistance properties of the polymers. The thermographs are presented in FIG. 6, with the respective char residue values (wt. %) summarized in Table 4. All films exhibited similar degradation trends, indicating that the inclusion of PP and MOF did not alter the degradation mechanism. It is evident that thermal stability increases with the incorporation of MOF, with a significant improvement observed at 1.0 wt. % MOF content. Degradation occurred mainly in two steps: the first at 250° C. for urethane groups and the second at 312° C. for urea groups. The degradation resistance improved in both cases. The enhancement in thermal stability can be attributed to the MOF structure, which interacts directly with the polymer chain and forms a barrier to gas permeation, ultimately increasing thermal stability in the presence of MOF.

Polyurethanes (PU), as a significant family of polymers, are widely utilized in the coatings industry due to their remarkable outdoor durability and rapid curing properties. However, their thermal and mechanical characteristics have limited their applications, necessitating certain modifications. Coatings with high hardness can be produced using polyurethanes modified with MOF addition. A Shore durometer test was conducted to measure the hardness of the prepared materials. The pristine PU and PU/PP coatings (first series) were only slightly affected by changes in monomer contents. A significant increase in hardness, from 70 to 83, was recorded with the incorporation of MOF, which can be attributed to the presence of the MOF particles. A tensile test was also performed to evaluate the mechanical performance of the films, with values summarized in Table 4. All values, except for elongation at break (%), increased with increasing MOF content. Elongation at break (%) was slightly compromised at higher MOF content. The MOF acted as a reinforcement, enhancing mechanical strength, as the MOF cages resisted the deformation of the base polymer chains, resulting in higher tensile strength and Young's modulus values.

The char residue (wt. %) from TGA analysis can predict the flame retardance of polymer/coating materials, with respective values summarized in Table 4. The pristine PU coating exhibited minimal fire resistance, with a maximum char residue of 3.0 wt. %. Fire retardance improved moderately with PP inclusion, with char content increasing up to 8.40 wt. %. The char content (wt. %) increased more significantly with higher MOF content, with minimal differences at lower MOF levels and substantial differences at higher levels, increasing from 8.4 to 13.7 wt. %. This indicates a clear improvement in flame retardance properties. The char produced can impede the passage of volatile gases, effectively insulating the surrounding environment from heat, thereby enhancing fire safety.

The fire resistance of the coatings was also evaluated using LOI analysis (see Table 4). A higher LOI value indicates a greater level of fire resistance. The LOI values increased with the addition of PP and continued to rise with increasing PP content. Notably, LOI values increased rapidly with higher MOF content, reaching around 30% for PU4/PP4-MOF3, suggesting promising fire-retardant properties.

### Example 15: UV and Hydrogen Exposure

It is common for external coatings to face various natural weather conditions. The coatings were exposed to seaside conditions for 12 months. The coatings were also assessed for UV degradation, as UV-degraded coatings may lose their fire-retardant properties. Visually, all coatings remained free of cracking or delamination. The exposed coatings were analyzed using XPS. A peak corresponding to the CO group in the XPS analysis confirmed coating degradation. Since the PU coating contains CO groups, an increase in the intensity of this band typically indicates degradation. The intensity for the PU4/PP4-MOF4 coating was slightly higher for the CO group in the exposed coating, suggesting some degradation; however, it was not significant enough to compromise the coating's integrity. Thus, the coating was only minimally affected during this exposure period. Both the char residue (from TGA analysis) and LOI values (see Table 4) showed slight decreases, but the deviations were the lowest among all coatings, confirming that the PU4/PP4-MOF4 coating retained its fire-retardant properties after exposure.

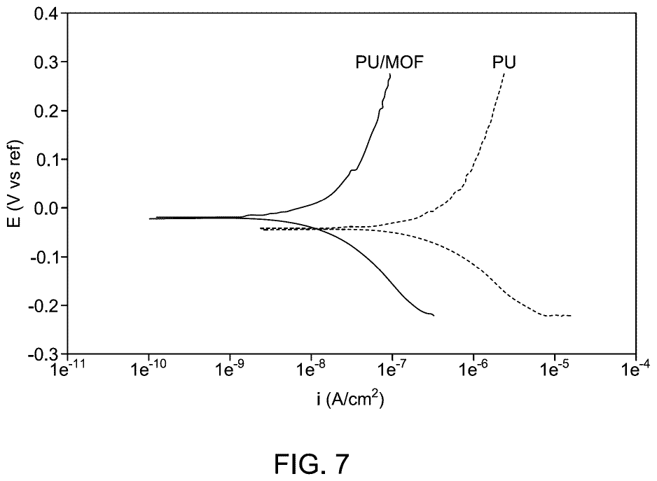

The protective properties of the coating were further evaluated using potentiodynamic polarization (PDP) analysis to assess corrosion resistance. The PDP curve is shown in FIG. 7. The i_{corr} value decreased with the inclusion of MOF and continued to decline with increasing MOF content. The maximum reduction was observed with the highest MOF content, confirming enhanced protection of the coating.

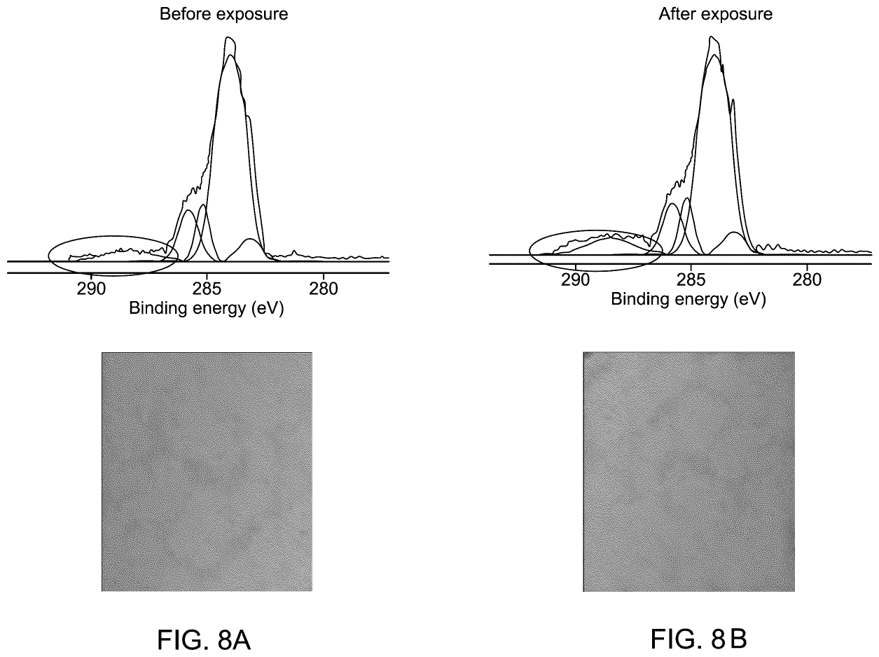

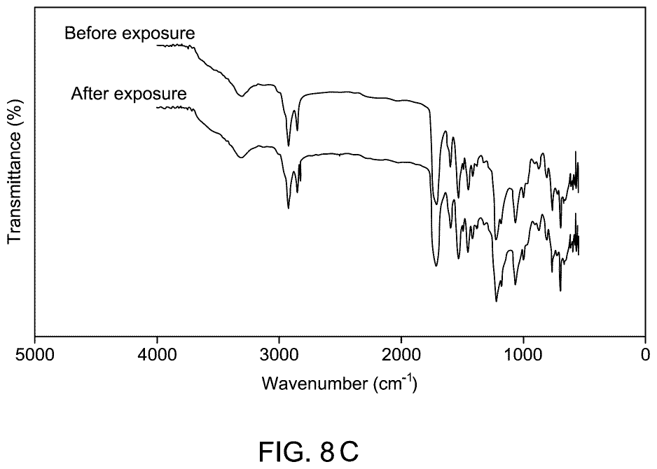

Both the coated liner and coated mild steel specimens were maintained in a hydrogen environment. The unexposed and exposed coating images are presented in FIGS. 8A-8B, respectively. No changes were observed after aging, although some coatings experienced minor delamination.

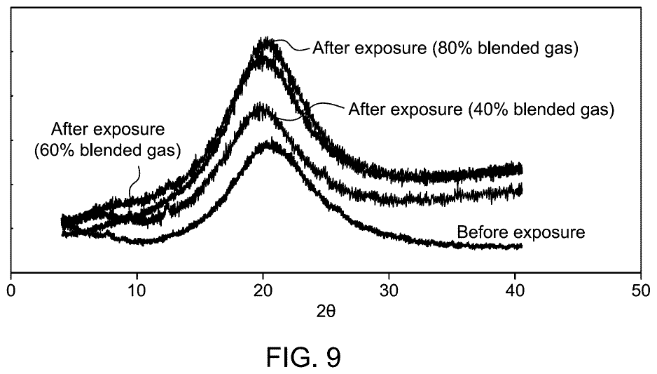

FT-IR (FIG. 8C), XRD (FIG. 9), and SEM analyses were conducted to evaluate changes in the chemical composition and microstructure of the coatings after aging in a hydrogen/blended gases environment. The FT-IR spectra showed almost identical peaks for liners and coatings, confirming that the chemical composition was unaffected in the hydrogen environment. The hydrogen concentration did not significantly influence the chemical structure or functional groups.

However, an XRD pattern was observed for aged coatings compared to untreated ones. Only a typical PU hollow peak appeared for both aged and non-aged coatings, confirming an amorphous coating that maintains its structure under various blended gases. Although the intensity of the peaks changed with different gas ratios, these changes were not systematic, but were clearly noticeable, indicating slight modifications in the microstructure of PU materials in the hydrogen environment.

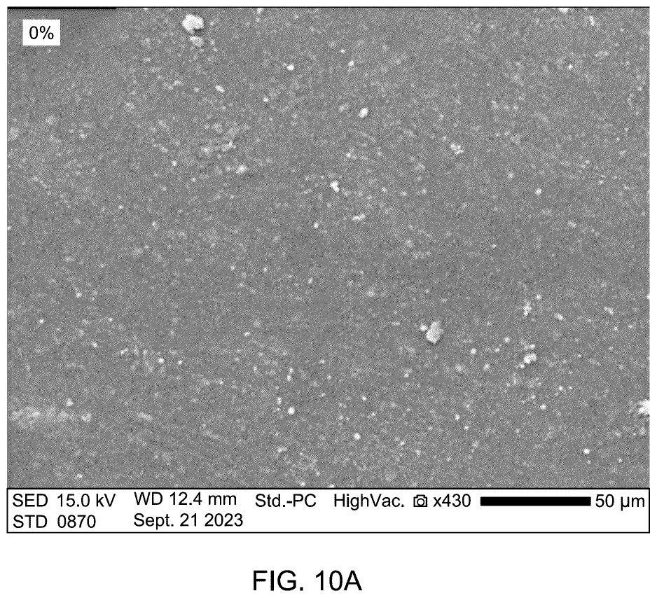

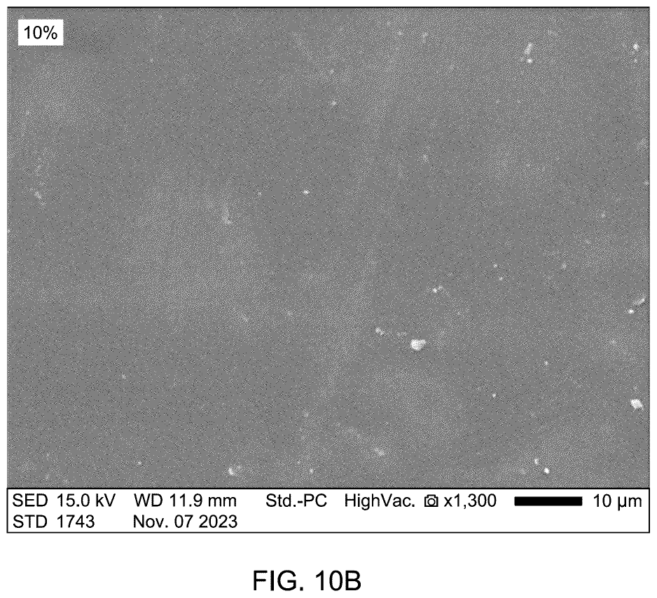

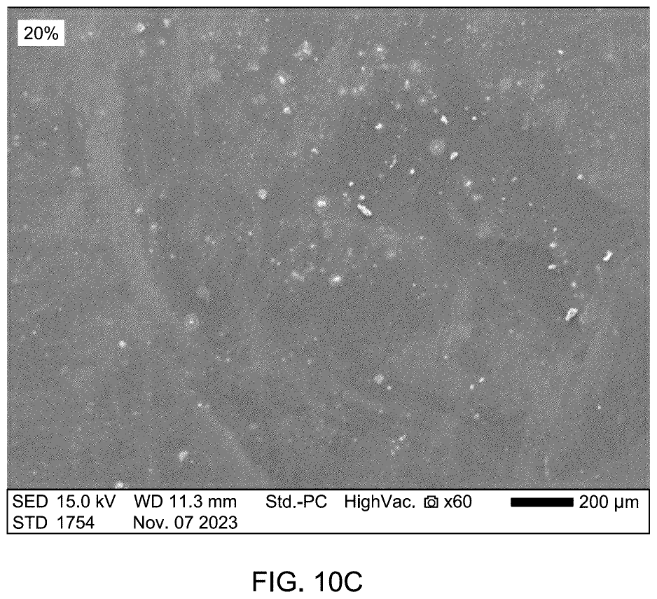

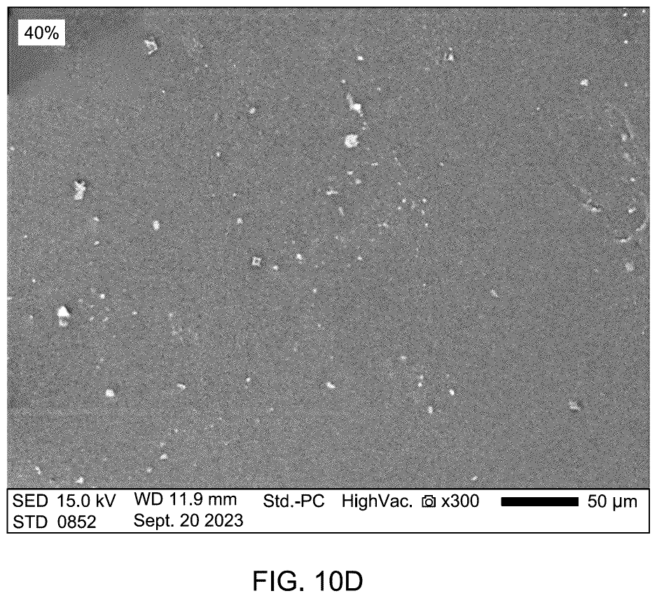

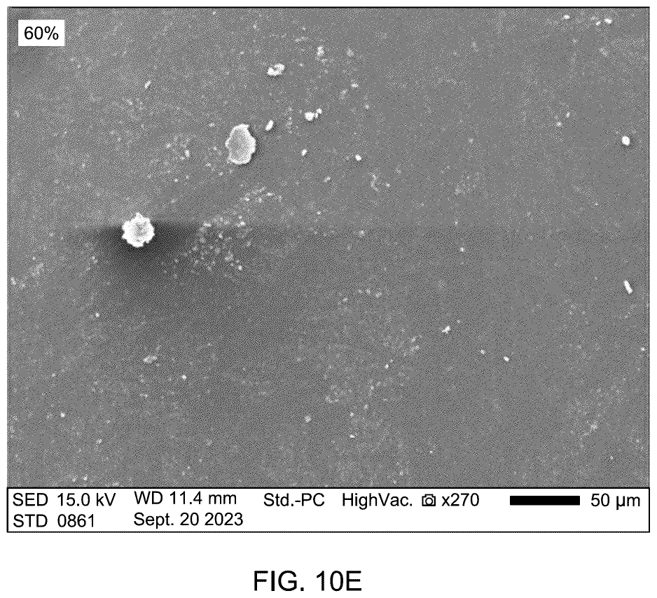

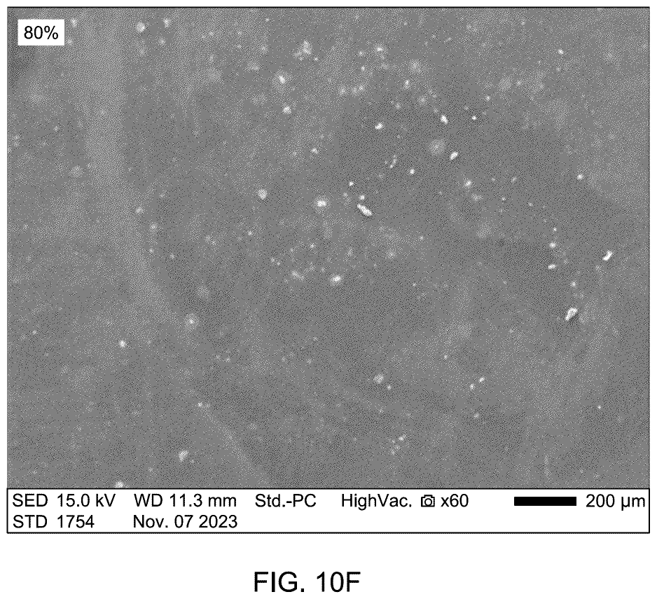

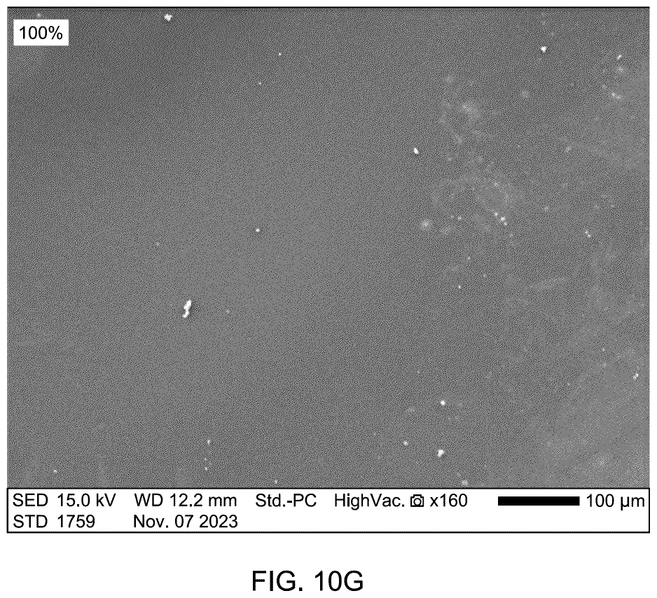

SEM microphotographs are displayed in FIGS. 10A-10G. While the microphotographs are slightly different, no cracking was observed, indicating that the coatings were free from microdamage at varying gas concentrations. This also suggests microstructural changes occurred at different blended gas concentrations, consistent with the XRD analysis.

The materials discussed herein may be advantageous for use as external coatings with high fire retardance and as internal coatings on liners to enhance barriers against hydrogen embrittlement. Incorporation of specific amounts of phosphol and metal-organic frameworks (MOFs) may improve both fire retardance and diffusion resistance. The coatings demonstrated chemical stability in hydrogen environments, with only slight microstructural changes observed, preserving their original characteristics. Notably, tensile strength, Young's modulus, and hardness values were found to increase with higher MOF content. Additionally, corrosion resistance and fire retardance were found to improve with 1.0 wt. % MOF content. The coating designated as PU4/PP4-MOF4 exhibited minimal degradation under real atmospheric conditions, maintaining its fire-retardant properties. This coating may be well-suited for industrial applications in hydrogen transmission pipelines.

Numerous modifications and variations of the present disclosure are possible in light of the above teachings. It is therefore to be understood that within the scope of the appended claims, the invention may be practiced otherwise than as specifically described herein.

1. A fire-retardant material, comprising
a polymer matrix comprising, in reacted form
a diisocyanate,
a chain extender,
a carboxylate-comprising organic diol,
an organophosphorus-containing polyol,
an organophosphorus-free polyol, and
0.05 to 2.5 wt. % of a metal-organic framework, based on a total weight of the fire-retardant material, wherein
the diisocyanate and the phosphorous-containing polyol are present in the polymer matrix a mole ratio of 1:1 to 50:1.

2. The fire-retardant material of claim 1, wherein
the diisocyanate is 4,4-dicyclohexylmethane diisocyanate,
the chain extender is ethylene diamine, and
the carboxylate-comprising organic diol is dimethylolpropionic acid.

3. The fire-retardant material of claim 2, wherein
the polymer matrix comprises 18 to 30 mol % dimethylolpropionic acid.

4. The fire-retardant material of claim 1, wherein
the organophosphorus-containing polyol has a structure represented by the following formula (1) 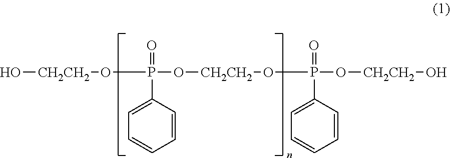
where n is an integer from 1 to 100,000.

5. The fire-retardant material of claim 1, wherein
the organophosphorus-free polyol is poly(tetramethyleneoxide glycol).

6. The fire-retardant material of claim 1, having
a mole ratio of the organophosphorus-free polyol and the organophosphorus-containing polyol of 1:1 to 5:1.

7. The fire-retardant material of claim 1, wherein
the metal-organic framework is UiO-66-OH.

8. The fire-retardant material of claim 1, having
a water swelling of 5.0 to 9.0%; and
a water contact angle of 70 to 100°.

9. The fire-retardant material of claim 1, having
a Shore A hardness of 70 to 85;
a tensile strength of 22.5 to 29.5 MPa; and
a young's modulus of 3 to 10 MPa.

10. The fire-retardant material of claim 1, having
a limiting oxygen index of 22.5 to 35; and
a residue char of 7.5 to 15 wt. % based on an initial weight of fire-retardant material.

11. A method of forming the fire-retardant material of claim 1, the method comprising
forming a short-chain prepolymer by reacting 4,4-dicyclohexylmethane diisocyanate, dimethylolpropionic acid, the organophosphorus-containing polyol, and the organophosphorus-free polyol in the presence of a polymerization catalyst;
dispersing the short-chain prepolymer in water to form a short-chain prepolymer dispersion,
chain extending the short-chain prepolymer by reacting the short-chain prepolymer with ethylene diamine to form a chain-extended poly(urethane) dispersion;
mixing the chain-extended poly(urethane) dispersion with the metal-organic framework to form a mixed dispersion; and
drying the mixed dispersion to form the fire-retardant material.

12. The method of claim 11, wherein
the chain-extended poly(urethane) dispersion has a solid content of 20 to 45 wt. % based on a total weight of chain-extended poly(urethane) dispersion.

13. The method of claim 11, wherein
the organophosphorus-free polyol is poly(tetramethyleneoxide glycol).

14. The method of claim 11, wherein
the organophosphorus-containing polyol has a structure represented by the following formula (1) 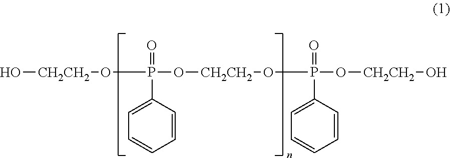
where n is an integer from 1 to 100,000.

15. The method of claim 11, wherein
the metal-organic framework is UiO-66-OH.

16. The method of claim 11, wherein
the polymerization catalyst is dibutyltin dilaurate.

17. The method of claim 11, wherein
the forming is performed at a polymerization temperature of 70 to 100° C.; and
the chain extending is performed at a chain extension temperature of 25 to 60° C.

18. A method of passivating a surface against hydrogen embrittlement, the method comprising applying to the surface the fire-retardant material of claim 1.

19. The method of claim 18, wherein
the fire-retardant material is applied to the surface as a coating having a thickness of 25 to 500 μm.

20. The method of claim 18, wherein
the fire-retardant material shows no detectable change in FTIR peak positions after exposure to a gas mixture comprising 10 to 90% hydrogen for 1 to 96 hours, compared to FTIR peak positions of the fire-retardant material prior to the exposure.
